(19) United States
(12) Patent Application Publication
(10) Pub. No.: US 2015/0041483 A1
(43) Pub. Date: Feb. 12, 2015

(54) AUTOMATION SYSTEM FOR DIAMOND BAGGING

(71) Applicants: Lalgudi Ramanathan Natarajan, Hosur (IN); R. Vivekanandan, Hosur (IN); Pachiappan Radhamanalan, Hosur (IN); Ganapathy Rajendran, Hosur (IN); R. Marxmani, Hosur (IN); P. Balasubramanian, Hosur (IN)

(72) Inventors: Lalgudi Ramanathan Natarajan, Hosur (IN); R. Vivekanandan, Hosur (IN); Pachiappan Radhamanalan, Hosur (IN); Ganapathy Rajendran, Hosur (IN); R. Marxmani, Hosur (IN); P. Balasubramanian, Hosur (IN)

(73) Assignee: TITAN INDUSTRIES LTD., Hosur (IN)

(21) Appl. No.: 14/126,424

(22) PCT Filed: Jun. 15, 2012
(86) PCT No.: PCT/IN2012/000429

§ 371 Date: Dec. 14, 2013

(30) Foreign Application Priority Data
Jun. 15, 2011 (IN) 2039/CHE/2011

(51) Int. Cl. G06M 1/272; B65B 35/10

(52) U.S. Cl. CPC G06M 1/272; B65B 35/10
USPC 221/1; 53/52

(57) ABSTRACT

A system for counting diamonds includes a rotary table configured to accommodate diamonds, a collection box assembly provided in communication with the rotary table, an ejecting mechanism configured to enable controlled ejection of said diamonds from the rotary table to the collection box assembly, at least one scanner and a controller configured to regulate functioning of at least one of the rotary table, the collection box assembly, the ejecting mechanism and the scanner. Further, the scanner is configured to determine the number of diamonds collected in the collection box assembly.

### FIELD OF INVENTION

The embodiments of this invention relate to jewelry manufacturing and, more particularly but not exclusively the embodiments of this invention relate to a process of counting and bagging diamonds according to product requirement during the course of diamond jewelry manufacturing.

### BACKGROUND OF INVENTION

The jewelry industry at present is on the rise all over the world. Increase in demand for jewelry requires the jewelry manufacturing industries to optimize the methods of manufacturing jewelry to produce more jewels in minimum duration thereby meeting the expectations of the customers. Further, as the precious stones, such as diamonds, used in jewelry are expensive in nature, the process of manufacturing jewels should obviate any errors, such as errors in counting, categorizing or bagging of such precious stones etc., which may occur during the course of manufacturing the jewelry.

Generally, in diamond jewelry manufacturing, the diamonds are categorized based on color, luster, clarity, cut etc. Conventionally, this categorization of diamonds is being done by using GIA (Gemological Institute of America) International Diamond Grading System. For example, GIA's proprietary color scale is used to categorize the diamonds based on its color. The color scale begins with the symbol “,” and goes up to the alphabet “Z” for light colored diamonds. Similarly, GIA International Diamond Grading System has GIA's Clarity scale and GIA's cut scale to categorize the diamonds based on clarity and cut as well. Further, the diamonds will be counted and bagged according to the requirement of the product.

At present, the process of counting and bagging of diamonds according to the requirement of the product is performed by counting and bagging of the diamonds manually by skilled persons. Further, bags containing diamonds are again checked for the correctness in the number of diamonds and then the diamonds are moved into the manufacturing unit for further processing.

The counting and bagging of diamonds manually as discussed above consumes more time thereby making the whole process partly inefficient. It is estimated that by the manual process of counting and bagging the diamonds, an employee can count and bag approximately 50 to 60 bags (i.e., 1000 Stones in about 8 hours), which is insufficient to meet the rising need for jewelry among the customers.

Also, the manual process of counting and bagging the diamonds as discussed above demands proper training and/or awareness to the employees at least due to the high value of diamonds. As the skilled employees are used for manual bagging of diamonds, which amounts to non-value added activity, it is not possible to utilize the employees for the value added activity.

Further, manual process of counting and bagging the diamonds is more often subject to human errors, prone for counting error, diamond mix-up, weighing mismatch, error in system documentation and so on. Further, as discussed above, the manual process of counting and bagging the diamonds consumes more time thereby making the conventional process partially inefficient.

Therefore, there is a need for a system in jewelry manufacturing industries that can overcome the above mentioned drawbacks. Further, there is a need for a system that can be operated automatically and can be used in counting and bagging diamonds.

### Object of Invention

The principal object of the invention is to provide an automatic system for counting and bagging diamonds according to the product requirement.

A further object of the invention is to provide a system for counting and bagging diamonds that increases the productivity by minimizing human intervention.

Yet another object of the invention is to provide a system that could eliminate human error in the process of counting and bagging diamonds.

Yet another object of the invention is to provide a method for counting and bagging diamonds based on product requirement.

These and other objects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF FIGURES

This invention is illustrated in the accompanying drawings, throughout which like reference letters indicate corresponding parts in the various figures. The embodiments herein will be better understood from the following description with reference to the drawings, in which:

FIG. 1 depicts an isometric view of a system for counting and bagging diamonds according to an embodiment of the present invention.

FIG. 2 depicts a front view of a system for counting and bagging diamonds according to an embodiment of the present invention.

FIG. 3 depicts a side view of a system for counting and bagging diamonds according to an embodiment of the present invention.

FIG. 4 depicts a top view illustrating a system for counting and bagging diamonds according to an embodiment of the present invention.

FIG. 5 depicts an isometric top view illustrating a system with a packing assembly for counting and bagging diamonds according to an embodiment of the present invention.

FIG. 6 depicts a sectional side view illustrating a system with a packing assembly for counting and bagging diamonds according to an embodiment of the present invention.

FIG. 7 depicts a sectional top view illustrating a system for counting and bagging diamonds according to an embodiment of the present invention.

FIG. 8 depicts a flow chart depicting a method for counting and bagging diamonds automatically according to an embodiment of the present invention.

### DETAILED DESCRIPTION OF INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. For example, it should be noted that while some embodiments are explained with respect to electric tractors for the ease of describing, other vehicles apart from electric tractors may also incorporate the subject matter of the invention with little or no modifications. Accordingly, the examples should not be construed as limiting the scope of the embodiments herein.

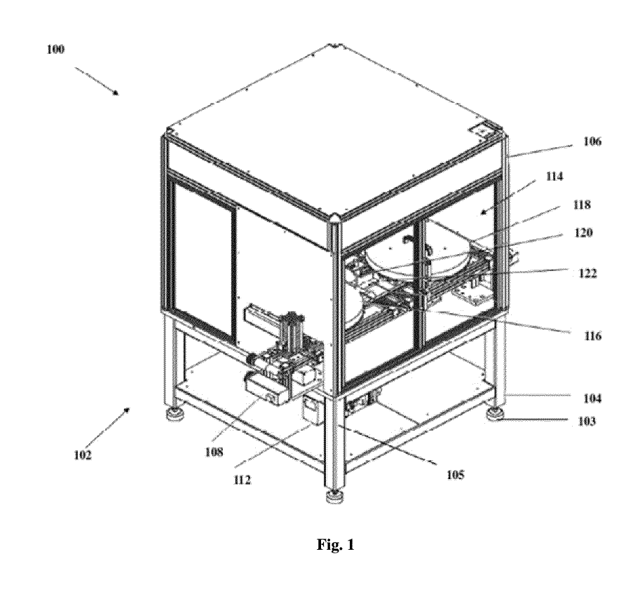

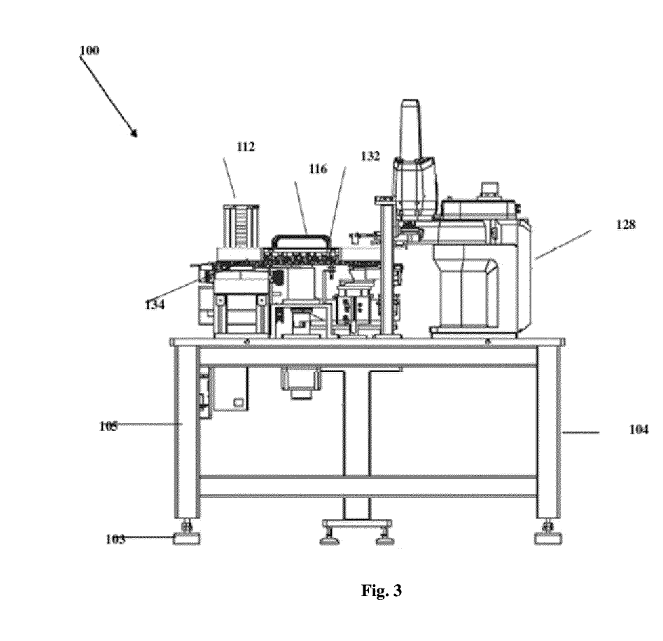

The embodiments herein provide a system for counting and bagging diamonds. Further, the embodiments herein provide method for counting and bagging diamonds automatically. Referring now to the drawings, and more particularly to FIGS. 1 through 5, where similar reference characters denote corresponding features consistently throughout the figures, there are shown embodiments.

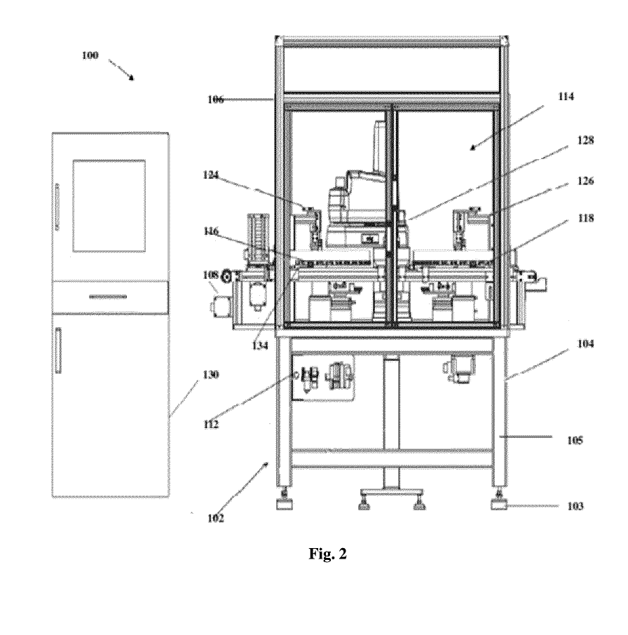

FIG. 1 and FIG. 2 depict an isometric view and a side view of a system 100 according to the embodiments of the present invention. The system 100 includes a base assembly 102 and a rotor assembly 114. In an embodiment, the base assembly 102 includes a base 104. In an embodiment, the base 104 includes a connecting element 105 that extend from the rotor assembly 114 to ground and a wheel 103 that is configured to move, rotate or fix the system 100 to the ground. In an embodiment, the base 104 is made of any rigid material.

In another embodiment, the base assembly 102 includes an enclosure 106. In an embodiment, the enclosure 106 is made of transparent or semi transparent rigid material that can be used to protect and cover rotor assembly 114. However, it is also within the scope of invention that the enclosure 106 could be made of any other material without otherwise deterring the intended function of the enclosure 106 as can be deduced from this description. In an embodiment, the enclosure 106 may be opened from at least one side, thereby enabling the user to manage the rotor assembly 114 manually. The rotor assembly 114 includes at least one rotary table 116. In an embodiment, the rotor assembly includes two rotary tables 116 and 118. Hence, it should be noted that the configuration of different elements with rotary table 116 could be applied for the rotary table 118.

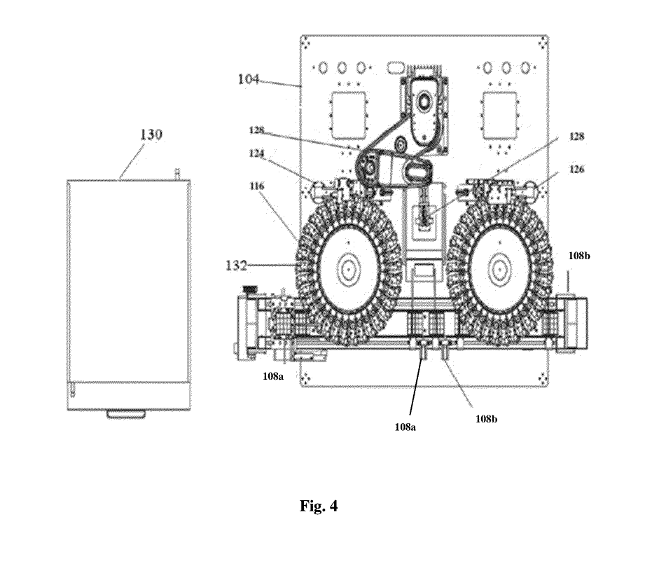

In another embodiment, the base assembly 102 includes a collection box assembly 108. In an embodiment, the collection box assembly 108 is provided in communication with the rotary table 116. In an embodiment, the collection box assembly 108 is provided on the base 102 and beneath a rotary table 116. The collection box assembly 108 is configured to collect the diamonds from the rotary table 116. In another embodiment, the base assembly 102 includes a controller mount box 112, the controller mount box 112 acts as a housing that can accommodate the motor (not shown) and the system on/off/pause/reset switch. In yet another embodiment, the base assembly 102 includes a collection box assembly 108a that is provided in communication with rotary table 116 and a collection box assembly 108b that is provided in communication with rotary table 118 (see FIG. 4). Further, both the collection box assembly 108a and 108b includes a similar configuration as collection box assembly 108.

In an embodiment, the rotary table 116 is configured to accommodate diamonds. In another embodiment, the rotary table 116 includes plurality of housing 132 as shown in FIG. 4. Each housing 132 is configured to accommodate different sizes and different categories of diamonds. In an embodiment, cup shaped housing could be used in the rotary table 116. However, it is also within the scope of invention that the housing 132 could be of different shape and design without otherwise deterring intended function of the housing 132 and the rotary table 116 as could be deduced from this description. In an embodiment, the housing 132 includes a covered bottom surface and partially opened top surface. The diamonds are of different categories such as VVS1, VVS, Si2GH, and Si2LM. Further, each housing 132 is configured to accommodate different sizes and different categories of diamonds. Further, information about category of diamonds in each housing 132 is stored in a personal computer or controller 130.

Furthermore, the rotor assembly 114 includes a rotary actuator 120 which is connected to the rotary table 116. In an embodiment, the rotary actuator 120 could be selected from an electric motor. However, it is also within the scope of invention that any other type of actuators that could be used to rotate rotor assembly 114 could be used as the rotary actuator 120, without otherwise deterring the intended function of the rotary actuator 120 and rotor assembly 114 as can be deduced from this description. A rotary actuator 120 can be used to actuate the rotary table 116. Further, the rotor assembly 114 includes a personal computer 130 that is configured to store information that include but are not limited to stone details, quantity of the diamonds required, category of the diamonds required, sizes of the diamonds required and so on. In an embodiment, the information could be uploaded using a guide card or similar means. In an embodiment, the personal computer 130 could be replaced by a controller such as programmable logic controller, without otherwise deterring intended function of the personal computer as can be deduced from this description.

In another embodiment, the rotor assembly 114 further includes a lever assembly 124. The lever assembly is provided in communication with the personal computer 130. In an embodiment, the personal computer or controller 130 is configured to regulate functioning of at least one of rotor assembly 114 and lever assembly 124. Further, the lever assembly 124 is configured to provide programmed movement to the rotor assembly 114 based on the instruction received from the personal computer or controller 130. In an embodiment, lever assembly 124 is provided at the top of rotary table 116 thereby enabling programmed movement to the rotary table 116 as per the program store in personal computer or controller 130. In an embodiment, the personal computer or controller 130 is configured to regulate functioning of all other electro mechanical components of system 100. Further, lever assembly 126 similar to the lever assembly 124 could be provided for actuating the rotary table 118.

Further, the rotary assembly 114 includes an ejecting mechanism 122. In an embodiment, the ejecting mechanism is a vibrator assembly. However, it is also within the scope of invention that the vibrator assembly can be replaced by any other ejecting mechanism that could be configured to enable controlled ejection of diamonds from the housing 132. In an embodiment, the vibrator assembly 122 is provided in communication with the rotary table 116. In an embodiment, the robot 128 is selected from any pick and place robot. In an embodiment, the robot 128 is provided at the base 104. Further, the robot 128 is configured to pick and place diamonds according to the programs stored in personal computer or controller 130. In an embodiment, the system 100 includes a weighing machine (not shown) that is provided in communication with the personal computer or controller 130. The weighing machine is configured to determine the weight of diamonds that is obtained and transfer the determined data to personal computer or controller 130. Further, the robot 128 is configured to pick and place the diamonds provided in the collection box assembly 108 according to the programs stored in personal computer or controller 130 in the weighing machine. In an embodiment, the system 100 includes plurality of weighing machine. For example, the system 100 includes two weighing machine that are configured to weigh the diamonds obtained in the collection box assembly 108a that is provided in communication with rotary table 116 and the collection box assembly 108b that is provided in communication with rotary table 118 separately. Providing individual weighing machines in order to receive the diamonds from rotary table 116 and rotary table 118 separately enables effective utilization of robot 128 by reducing the total time consumption for weighing process. Further, the reduction in the consumption of time subsequently results in the increase in overall production.

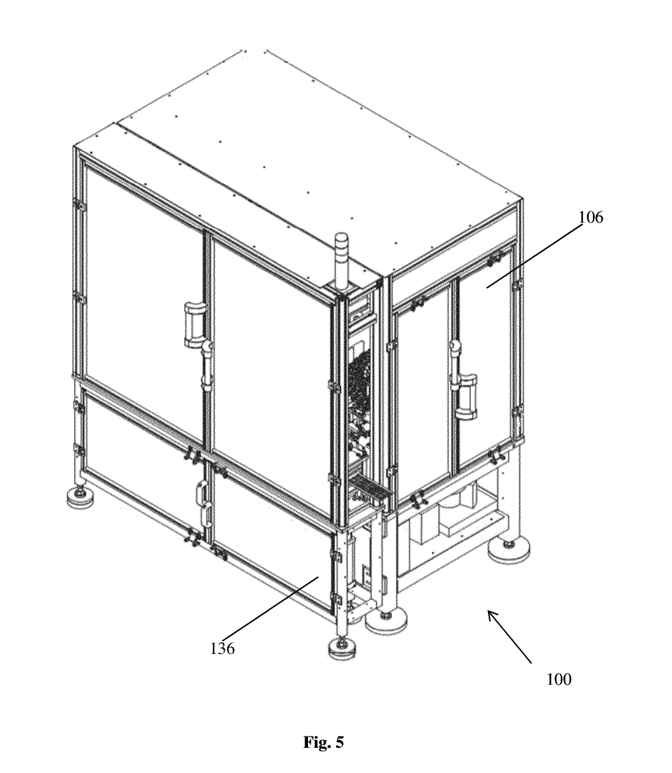

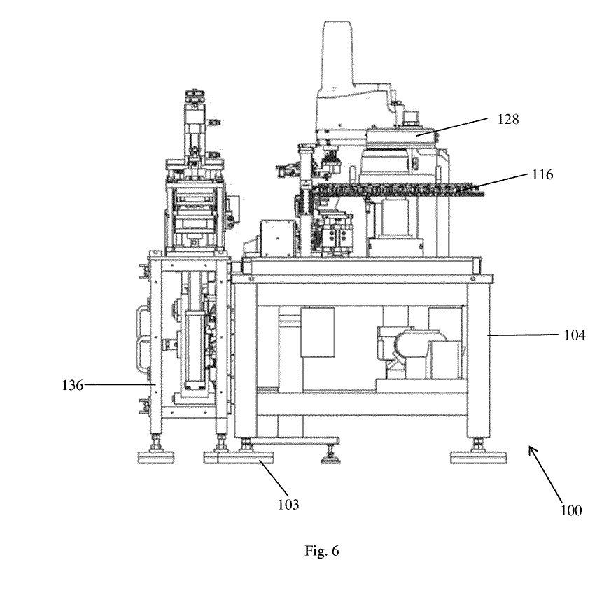

In another embodiment, the system 100 includes a printer (not shown) that is provided in communication with the personal computer or controller 130. The printer is configured to print the stone details along with the quantity and weight of the diamonds. In one embodiment, the printer is selected from inkjet printer. However, it is also within the scope of invention that the printer could be selected from any other type of printer without otherwise deterring intended function of the system 100 as could be deduced from this description. FIGS. 5 and 6 depicts an isometric top view and sectional side view of a system with a packing assembly for counting and bagging diamonds according to an embodiment of the present invention.

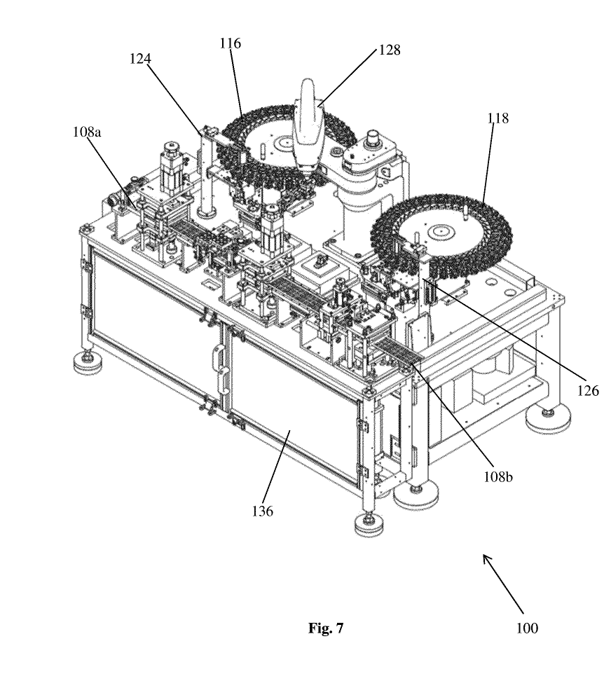

Further, in order to enhance the diamond quality and supply the diamonds obtained in the weighing machine are packed using appropriate user desired packing methods. In an embodiment, the diamonds are packed using blister packing 136. In an embodiment, the blister packing includes a cavity or pocket made from a formable web, usually a thermoformed plastic. This usually has a backing of paperboard or a lidding seal of aluminum foil or plastic. FIG. 7 depicts a sectional top view illustrating a system for counting and bagging diamonds according to an embodiment of the present invention.

In an embodiment, the rotor assembly 114 includes a sensor 134. The sensor is provided in communication with the collection box assembly and is connected to the personal computer or controller 130. The sensor 134 is configured to sense the quantity of diamonds and further transfers the information on the quantity of diamonds to the personal computer or controller 130.

In another embodiment, the system 100 includes an Enterprise resource planning (ERP) systems that are provided in communication with other electro mechanical components of the system 100. ERP systems integrate internal and external management information by using an integrated software application. Further, the ERP systems facilitates the flow of obtained information between all the electro mechanical components of the system 100.

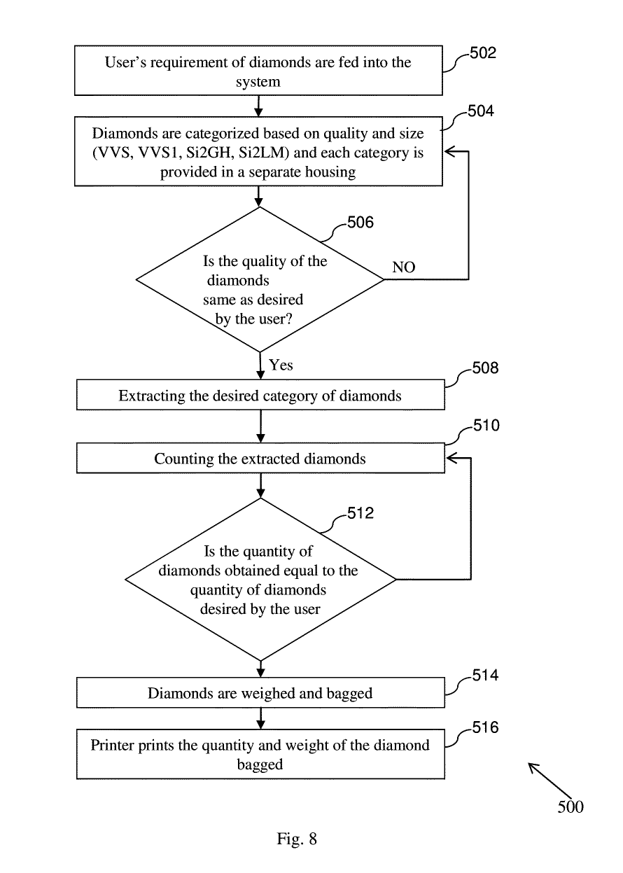

FIG. 8 depicts a flow chart that describes the process of counting and bagging the diamonds using a system according to the present invention. The user's requirement for diamond such as quantity of the diamonds required, category of the diamonds required, sizes of the diamonds required etc is uploaded in a guide card or similar means and the guide card is fed into a personal computer or controller 130 (Step 502). The diamonds are of different categories such as VVS1, VVS, Si2GH, and Si2LM. Further, each category of diamonds and different sizes of diamonds are stored in separate housing 132 (step 504). Further, information about category of diamonds in each housing 132 is stored in personal computer or controller 130. FIG. 4 depicts a top view illustrating a system for counting and bagging diamonds according to an embodiment of the present invention. Further, the personal computer or controller 130 checks whether at least one of category of diamonds and size of diamonds are available in the housing 132. Further, if at least one of category of diamonds and size of diamonds are not available in housing 132, the personal computer or controller 130 will alert the user and requires the user to provide desired category of diamonds and size of diamonds in the housing 132 (Step 506).

Further, once the system 100 is set to operate by pressing the ON switch in the controller mount box 112. The lever assembly 124 provides a programmable movement to the rotary table 116. In an embodiment, the personal computer or controller 130 regulates the function of lever assembly 124 based on the information stored in the personal computer or controller 130. In an embodiment, the personal computer or controller 130 is configured to regulate functioning of the lever assembly such that the housing 130 that accommodates the user required category of diamonds is moved to an axis perpendicular to the collection box assembly 108. Further, the vibrator unit 122 is set to vibrate. The force that is produced because of vibration enables the diamonds to fall into the collection box assembly that is placed beneath the rotary table 116 (step 508). Further, the sensor 134 provided near the collection box assembly 108 senses the quantity (Step 510) of the diamonds dropped in the collection box assembly 108 and transfers the information to the personal computer or controller 130. Further, the personal computer or controller 130 evaluates the quantity of diamonds in the collection box assembly 108 and the user requirement for diamonds (step 512). If the diamonds collected in the collection box matches the requirement specified by user, personal computer or controller 130 instructs the robot 128 to pick the diamonds from the collection box assembly 108 and place it in the bagging assembly (Step 514). In an embodiment, the bagging assembly is an element that is used to bag diamonds. In an embodiment, the personal computer or controller 130 instructs the robot 128 to pick the diamonds from the collection box assembly 108 and place it in a weighing machine (not shown) that is connected with the personal computer or controller 130. The weighing machine is configured to weigh the diamonds and passes the information to the personal computer or controller 130. Further, if the diamonds collected in the collection box assembly 108 does not match the requirement specified by the user, the personal computer 130 instruct the robot 128 to pick the diamonds from the collection box assembly 108 and place it back onto the rotary table 116. This process continues until the diamonds collected in the collection box 108 matches the user requirement for diamonds (step 512). In another embodiment, the system 100 includes a printer connected to the personal computer or controller 130 that is used to print the stone details along with the quantity and weight of the diamonds (Step 516). Further, the diamonds obtained in the weighing machine are packed using appropriate user desired methods.

Further, in another embodiment, the system 100 can be designed to accommodate any number of rotary tables that can accommodate different categories of diamond and different sizes of each category.

The various actions in process of FIG. 5 may be performed in the order presented, in a different order or simultaneously. Further, in some embodiments, some actions listed in FIG. 5 may be omitted.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims as described herein.

1. A system for counting diamonds, said system comprising:
a rotary table configured to accommodate diamonds;
a collection box assembly provided in communication with said rotary table;
an ejecting mechanism configured to enable controlled ejection of said diamonds from said rotary table to said collection box assembly;
at least one scanner; and
a controller configured to regulate functioning of at least one of said rotary table, said collection box assembly, said ejecting mechanism and said scanner,
wherein said scanner is configured to determine the number of said diamonds collected in said collection box assembly.

2. The system as claimed in claim 1, wherein said rotary table includes plurality of housing, wherein each of said plurality of housing is configured to accommodate diamonds of at least one of different size and different quality, and wherein each of said plurality of housing is provided in communication with said controller.

3. The system as claimed in claim 2, further comprising a lever assembly provided in communication with said controller, wherein said lever assembly is configured to provide programmed motion to said plurality of housing.

4. The system as claimed in claim 1, further comprising an actuator configured to rotate said rotary table.

5. The system as claimed in claim 1, wherein said ejection mechanism is a vibrator assembly that is configured to provide vibratory force on the rotary table.

6. The system as claimed in claim 1, further comprising at least one robot and a bagging assembly, wherein said robot is configured to move diamonds from collection box assembly to at least one of said rotary table and said bagging assembly.

7. The system as claimed in claim 6, wherein said bagging assembly includes a weighing machine that is configured to weigh said diamonds collected in the bagging assembly.

8. The system as claimed in claim 6, further comprising a printer provided in communication with said controller and configured to print the information with respect to at least one of said number of diamonds, said weight of diamonds, said size of diamonds and said quality of diamonds.

9. A method for counting diamonds, said method comprising:
providing plurality of diamonds;
providing controlled ejection of said plurality of diamonds; and
determining the number of diamonds.

10. A method for obtaining user desired diamonds, said method comprising:
obtaining information on at least one of desired number of diamonds from user, desired size of diamonds and desired quality of diamonds;
providing plurality of category of diamonds;
providing controlled ejection of at least one of said desired size of diamonds and desired quality of diamonds from said plurality of category of diamonds; and
determining the desired number of at least one of desired size of diamonds and desired quality of diamonds, wherein said each category of said plurality of category of diamonds includes uniform quality of diamonds and uniform size of diamonds.

11. The method as claimed in claim 10, further comprising:
determining weight of the desired number of diamonds; and
providing information on at least one of said number of diamonds, said size of diamonds, said quality of diamonds and said weight of the desired number of diamonds.
